(19) United States
(12) Patent Application Publication
(10) Pub. No.: US 2012/0262645 A1
(43) Pub. Date: Oct. 18, 2012

(54) Backlight Module and Liquid Crystal Display Employing Same

(76) Inventors: Quan Li, Shenzhen City (CN); Yi-Cheng Kuo, Shenzhen City (CN)

(21) Appl. No.: 13/260,358

(22) PCT Filed: May 19, 2011
(86) PCT No.: PCT/CN11/74351

§ 371 Date: Sep. 25, 2011

(30) Foreign Application Priority Data
Mar. 21, 2011 (CN) 201110067847.8

(51) Int. Cl. G02F 1/1335; F21V 13/02; F21V 13/12

(52) U.S. Cl. 349/64; 362/606; 362/608

(57) ABSTRACT

An exemplary backlight module includes two light guide plates, two first light sources, a diffusing plate, and a second light source. The two light guide plates are arranged apart from each other, and each of the light guide plates includes a first side surface and a second side surface. The first side surface is adjacent to the other light guide plate. The second side surface is opposite to the first side surface and is away from the other light guide plate. The two first light sources are arranged adjacent to the second side surfaces of the two light guide plates, respectively, and provide first light beams for the two light guide plates, respectively. The diffusing plate is arranged between the first side surfaces of the two light guide plates. The second light source is arranged below the diffusing plate and provides second light beams for the diffusing plate.

### TECHNICAL FIELD

The present disclosure generally relates to liquid crystal displays (LCDs), and more particularly relates to a backlight module and a liquid crystal display employing the backlight module.

### BACKGROUND

At present, liquid crystal displays are widely used in various electronic devices, such as computer monitors, TVs, notebooks, mobile phones and digital cameras, due to their advantages, such as slim shape, energy saving and low radiation. Liquid crystal material in the liquid crystal displays does not emit any light itself. Therefore, backlight modules are required in the liquid crystal displays to provide a planar light source.

In general, the backlight modules may be divided into direct light-type backlight modules and side light-type backlight modules in terms of their means of light-incidence. The side light-type backlight module needs a light guide plate, which increases a weight of the side light-type backlight module and makes it difficult to achieve local dimming effects in the side light-type backlight module. The direct light-type backlight module needs a plurality of LEDs, which increases a cost of the direct light-type backlight module. Furthermore, the direct light-type backlight module should have an enough thickness to achieve an improved light-mixing effect. There is no backlight module which is thin, low-cost, and easy to achieve local dimming effects.

What is needed, therefore, is a backlight module and a liquid crystal display which may overcome the above-described deficiencies.

### SUMMARY

Accordingly, the present disclosure provides a backlight module and a liquid crystal display employing the backlight module which is thin, low-cost, and easy to achieve local dimming effects.

The present disclosure provides a backlight module which includes two light guide plates, two first light sources, a diffusing plate, a second light source, an optical film and a bottom tray. The two light guide plates are arranged apart from each other, and each of the light guide plates includes a first side surface and a second side surface. The first side surface is adjacent to the other light guide plate. The second side surface is opposite to the first side surface and is away from the other light guide plate. The two first light sources are arranged adjacent to the second side surfaces of the two light guide plates, respectively, and provide first light beams for the two light guide plates, respectively. The diffusing plate is arranged between the first side surfaces of the two light guide plates. The second light source is arranged below the diffusing plate, and provides second light beams for the diffusing plate. The optical film is arranged above the light guide plates and the diffusing plate. The bottom tray is arranged below the light guide plates and the second light source, and supports the light guide plates and the second light source.

According to an exemplary embodiment of the present disclosure, each of the first side surfaces of the two light guide plates includes a first supporting member arranged thereon. Two end portions of the diffusing plate are supported on the first supporting members.

According to an exemplary embodiment of the present disclosure, the bottom tray includes two supporting portions apart from each other, and a downwardly depressed second supporting portion arranged between the two first supporting portions. The two light guide plates are supported on the two first supporting portions. The second light source is supported on the second supporting portion.

According to an exemplary embodiment of the present disclosure, the bottom tray further includes two second supporting members. Other two end portions of the diffusing plate are supported on the second supporting members of the bottom tray.

The present disclosure provides a backlight module which includes two light guide plates, two first light sources, a diffusing plate, and a second light source. The two light guide plates are arranged apart from each other, and each of the light guide plates includes a first side surface and a second side surface. The first side surface is adjacent to the other light guide plate. The second side surface is opposite to the first side surface and is away from the other light guide plate. The two first light sources are arranged adjacent to the second side surfaces of the two light guide plates, respectively, and provide first light beams for the two light guide plates, respectively. The diffusing plate is arranged between the first side surfaces of the two light guide plates. The second light source is arranged below the diffusing plate and provides second light beams for the diffusing plate.

According to an exemplary embodiment of the present disclosure, each of the first side surfaces of the two light guide plates includes a first supporting member arranged thereon. Two end portions of the diffusing plate are supported on the first supporting members.

According to an exemplary embodiment of the present disclosure, each of the first supporting members has a stepped structure. A height of the stepped structure is equal to that of the diffusing plate.

According to an exemplary embodiment of the present disclosure, the first supporting members project downwardly from the light guide plates.

According to an exemplary embodiment of the present disclosure, the backlight module further includes an optical film arranged above the light guide plates and the diffusing plate.

According to an exemplary embodiment of the present disclosure, the backlight module further includes a bottom tray. The bottom tray is arranged below the light guide plates and the second light source, and supports the light guide plates and the second light source.

According to an exemplary embodiment of the present disclosure, the bottom tray includes two first supporting portions apart from each other, and a downwardly depressed second supporting portion arranged between the two first supporting portions. The two light guide plates are supported on the two first supporting portions. The second light source is supported on the second supporting portion.

According to an exemplary embodiment of the present disclosure, the bottom tray further includes two second supporting members. Other two end portions of the diffusing plate are supported on the second supporting members of the bottom tray.

According to an exemplary embodiment of the present disclosure, the first light beams from the first light sources enter into the diffusing plate via the light guide plates.

The present disclosure provides a liquid crystal display which includes a backlight module. The backlight module includes two light guide plates, two first light sources, a diffusing plate and a second light source. The two light guide plates are arranged apart from each other, and each of the light guide plates includes a first side surface and a second side surface. The first side surface is adjacent to the other light guide plate. The second side surface is opposite to the first side surface and is away from the other light guide plate. The two first light sources are arranged adjacent to the second side surfaces of the two light guide plates, respectively, and provide first light beams for the two light guide plates, respectively. The diffusing plate is arranged between the first side surfaces of the two light guide plates. The second light source is arranged below the diffusing plate and provides second light beams for the diffusing plate.

According to an exemplary embodiment of the present disclosure, each of the first side surfaces of the two light guide plates includes a first supporting member arranged thereon. Two end portions of the diffusing plate are supported on the first supporting members.

According to an exemplary embodiment of the present disclosure, the backlight module further includes an optical film arranged above the light guide plates and the diffusing plate.

According to an exemplary embodiment of the present disclosure, the backlight module further includes a bottom tray arranged below the light guide plates and the second light source. The bottom tray supports the light guide plates and the second light source.

According to an exemplary embodiment of the present disclosure, the bottom tray includes two first supporting portions apart from each other, and a downwardly depressed second supporting portion arranged between the two first supporting portions. The two light guide plates are supported on the two first supporting portions. The second light source is supported on the second supporting portion.

According to an exemplary embodiment of the present disclosure, the bottom tray further includes two second supporting members. Other two end portions of the diffusing plate are supported on the second supporting members of the bottom tray.

According to an exemplary embodiment of the present disclosure, the first light beams from the first light sources enter into the diffusing plate via the light guide plates.

With the above-described configurations, the backlight modules of the present disclosure employ a combination of a side light-type backlight module and a direct light-type backlight module. Thus, the backlight modules of the present disclosure are thin, low-cost, and easy to achieve local dimming effects.

### BRIEF DESCRIPTION OF THE DRAWINGS

The components in the drawings are not necessarily drawn to scale, the emphasis instead being placed upon clearly illustrating the principles of at least one embodiment of the present disclosure. In the drawings, like reference numerals designate corresponding parts throughout various views, and all the views are schematic.

FIG. 1 shows a side view of a backlight module according to a first embodiment of the present disclosure.

FIG. 2 shows a side view of a backlight module according to a second embodiment of the present disclosure.

FIG. 3 shows a side view of a backlight module according to a third embodiment of the present disclosure.

### DETAILED DESCRIPTION OF EMBODIMENTS

Reference will now be made to the drawings to describe preferred and exemplary embodiments of the present disclosure in detail.

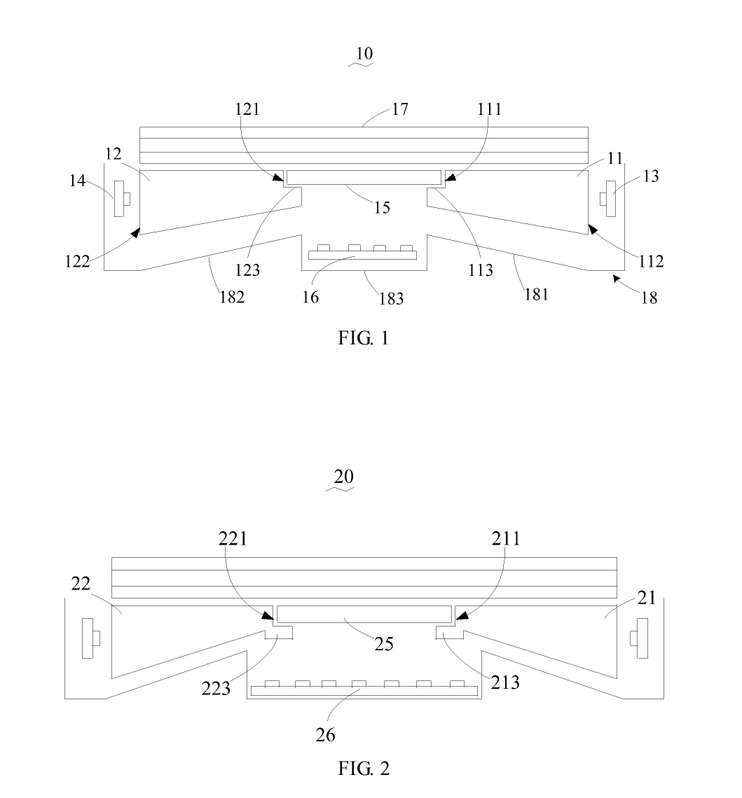

Referring to FIG. 1, a backlight module 10 according to a first embodiment of the present disclosure is shown. The backlight module 10 includes two light guide plates 11, 12, two first light sources 13, 14, a diffusing plate 15, a second light source 16, an optical film 17, and a bottom tray 18.

In the illustrated embodiment, the light guide plates 11, 12 are wedge-shaped, and are horizontally arranged with a distance therebetween. The light guide plate 11 includes a first side surface 111 and a second side surface 112. The first side surface 111 is adjacent to the light guide plate 12. The second side surface 112 is opposite to the first side surface 111 and is away from the light guide plate 12. A first supporting member 113 is arranged on the first side surface 111. The light guide plate 12 includes a first side surface 121 and a second side surface 122. The first side surface 121 is adjacent to the light guide plate 11, and the second side surface 122 is opposite to the first side surface 121 and is away from the light guide plate 11. A first supporting member 123 is arranged on the first side surface 121.

The first light source 13 is adjacent to the second side surface 112 of the light guide plate 11 for providing light beams for the light guide plate 11. The first light source 14 is adjacent to the second side surface 122 of the light guide plate 12 for providing light beams for the light guide plate 12. The first light source 13, 14 may be one or more light emitting diodes (LEDs) or cold cathode fluorescent lamps (CCFLs).

The diffusing plate 15 is arranged between the first side surface 111 of the light guide plate 11 and the first side surface 121 of the light guide plate 12. In the illustrated embodiment, two end portions of the diffusing plate 15 are supported on the first supporting member 113 and the first supporting member 123, respectively. The first supporting member 113 and the first supporting member 123 have a stepped structure, and a height of the stepped structure is equal to a height of the diffusing plate 15. Therefore, top surfaces of the light guide plates 11, 12 are coplanar with a top surface of the diffusing plate 15. In the illustrated embodiment, a height of the diffusing plate 15 is less than thicknesses of the light guide plates 11, 12 on the first side surfaces 111, 121, thus he first supporting member 113, 123 are directly formed in the light guide plates 11, 12, respectively. In alternative embodiment, the diffusing plate 15 may be supported between the first side surfaces 111, 121 of the light guide plates 11, 12 by adhesion or embedment.

The second light source is arranged below the diffusing plate 15 for providing light beams for the diffusing plate 15. The second light source 16 may be one or more LEDs or CCFLs.

The optical film 17 is arranged above the light guide plates 11, 12 and the diffusing plate 15. The optical film 17 may be a diffusion film, a brightness enhancement film, other proper films, or a combination thereof.

The bottom tray 18 is arranged below the light guide plates 11, 12 and the second light source 16 for supporting the light guide plates 11, 12 and the second light source 16. In detail, the bottom tray 18 includes two first supporting portions 181, 182 separated from each other and a downwardly depressed second supporting portion 183 arranged between the first supporting portions 181, 182. The light guide plates 11, 12 are supported on the first supporting portions 181, 182, respectively. The second light source 16 is supported on the second supporting portion 183. In the illustrated embodiment, the first supporting portions 181, 182 incline corresponding to inclined bottom surfaces of the light guide plates 11, 12. Moreover, the bottom tray 18 may further support the first light sources 13, 14. Two second supporting members (not shown) may be further arranged on the bottom tray 18 for supporting other two end portions of the diffusing plate 15, respectively.

The light beams from the first light sources 13, 14 enter into the light guide plates 11, 12 via the second side surfaces 112, 122, respectively, and finally emit out the light guide plates 11, 12 via the top surfaces of the light guide plate 11, 12 under scattering action of scattering patterns (not shown) or other scattering structures (not shown) on the bottom surfaces of the light guide plates 11, 12 and reflecting action of a reflecting coating (not shown) on the bottom tray 18 or a reflecting plate (not shown) between the light guide plates 11, 12 and the bottom tray 18. The light beams emitting out the light guide plates 11, 12 are further provided to a liquid crystal panel (not shown) after passing through the optical film 17.

The light beams from the second light sources 16 enter into the diffusing plate 15 via a bottom surface of the diffusing plate 15, and finally emit out the diffusing plate 15 via the top surface of the diffusing plate 15 after diffusing action of the diffusing plate 15. The light beams emitting out the diffusing plate 15 are further provided to the liquid crystal panel. A distance between the second light source 16 and the diffusing plate 15 is experimentally determined according to parameters of the optical film 17, the second light source 16, and the diffusing plate 15, and the distance is generally greater than the thicknesses of the light guide plates 11, 12. Therefore, the downwardly depressed second supporting portion 183 is arranged on the bottom tray 18 to support the second light source 16. A depressed depth of the second supporting member 183 is adjusted to keep a proper distance between the second light source 16 and the diffusing plate 15.

In other alternative embodiments, the first side surfaces 111, 121 of the light guide plates 11, 12 may include no reflective films or reflective layers arranged thereon for allowing a part of the light beams from the first light source 13, 14 entering into the diffusing plate 15 from the light guide plates 11, 12 and emitting out the diffusing plate 15 after being mixed with the light beams from the second light source 16. Thus, a light uniformity at junctions of the light guide plates 11, 12 and the diffusing plate 15 may be improved.

Referring to FIG. 2, a backlight module 20 according to a second embodiment of the present disclosure is shown. The backlight module 20 is similar to the backlight module 10 of the first embodiment except that a height of a diffusing plate 25 of the backlight module 20 is essentially equal to thicknesses of light guide plates 21, 22 on first side surfaces 211, 221. Therefore, first supporting members 213, 223 project downwardly from the light guide plates 21, 22 to ensure that top surfaces of the light guide plates 21, 22 may be coplanar with a top surface of the diffusing plate 25.

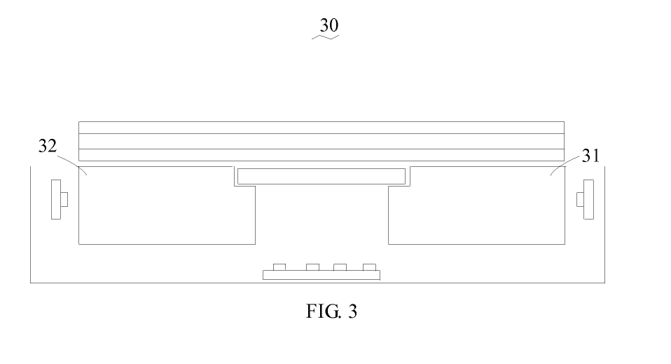

Referring to FIG. 3, a backlight module 30 according to a third embodiment of the present disclosure is shown. The backlight module 30 is similar to the backlight module 10 of the first embodiment except that light guide plates 31, 32 of the backlight module 30 are both planar.

With the above-described configurations, the backlight modules of the present disclosure employ a combination of a side-typed backlight module and a direct-typed backlight module. Therefore, the problem of increased weight caused by a bulky light guide plate in a pure side-typed backlight module may be avoided, and the problem of increased thickness in a pure direct-typed backlight module may also be avoided. Thus, the backlight modules of the present disclosure are thin, and the costs thereof are low. Alternatively, the first light sources and the second light source may be adjusted individually for achieving local-dimming effects.

A liquid crystal display is also provided in the present disclosure. The liquid crystal display includes a liquid crystal panel and a backlight module for providing light beams for the liquid crystal panel. The backlight module may be the backlight module 10, the backlight module 20, or the backlight module 30.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A backlight module, comprising:
two light guide plates arranged apart from each other, each of the light guide plates comprising a first side surface and a second side surface, the first side surface being adjacent to the other light guide plate, the second side surface being opposite to the first side surface and being away from the other light guide plate;
two first light sources arranged adjacent to the second side surfaces of the two light guide plates, respectively, and providing first light beams for the two light guide plates, respectively;
a diffusing plate arranged between the first side surfaces of the two light guide plates;
a second light source arranged below the diffusing plate and providing second light beams for the diffusing plate;
an optical film arranged above the light guide plates and the diffusing plate; and
a bottom tray arranged below the light guide plates and the second light source and supporting the light guide plates and the second light source.

2. The backlight module of claim 1, wherein each of the first side surfaces of the two light guide plates comprises a first supporting member arranged thereon, and two end portions of the diffusing plate are supported on the first supporting members.

3. The backlight module of claim 2, wherein the bottom tray comprises two supporting portions apart from each other, and a downwardly depressed second supporting portion arranged between the two first supporting portions, the two light guide plates being supported on the two first supporting portions and the second light source being supported on the second supporting portion.

4. The backlight module of claim 3, wherein the bottom tray further comprises two second supporting members, and other two end portions of the diffusing plate are supported on the second supporting members of the bottom tray.

5. A backlight module comprising:
two light guide plates arranged apart from each other, each of the light guide plates comprising a first side surface and a second side surface, the first side surface being adjacent to the other light guide plate, the second side surface being opposite to the first side surface and being away from the other light guide plate;
two first light sources arranged adjacent to the second side surfaces of the two light guide plates, respectively, and providing first light beams for the two light guide plates, respectively;
a diffusing plate arranged between the first side surfaces of the two light guide plates; and
a second light source arranged below the diffusing plate and providing second light beams for the diffusing plate.

6. The backlight module of claim 5, wherein each of the first side surfaces of the two light guide plates comprises a first supporting member arranged thereon, and two end portions of the diffusing plate are supported on the first supporting members.

7. The backlight module of claim 6, wherein each of the first supporting members has a stepped structure, and a height of the stepped structure is equal to that of the diffusing plate.

8. The backlight module of claim 6, wherein the first supporting members project downwardly from the light guide plates.

9. The backlight module of claim 6, further comprising an optical film arranged above the light guide plates and the diffusing plate.

10. The backlight module of claim 6, further comprising a bottom tray, wherein the bottom tray is arranged below the light guide plates and the second light source, and supports the light guide plates and the second light source.

11. The backlight module of claim 10, wherein the bottom tray comprises two first supporting portions apart from each other, and a downwardly depressed second supporting portion arranged between the two first supporting portions, the two light guide plates being supported on the two first supporting portions and the second light source being supported on the second supporting portion.

12. The backlight module of claim 11, wherein the bottom tray further comprises two second supporting members, and other two end portions of the diffusing plate are supported on the second supporting members of the bottom tray.

13. The backlight module of claim 5, wherein the first light beams from the first light sources enter into the diffusing plate via the light guide plates.

14. A liquid crystal display comprising a backlight module, the backlight module comprising:
two light guide plates arranged apart from each other, each of the light guide plates comprising a first side surface and a second side surface, the first side surface being adjacent to the other light guide plate, the second side surface being opposite to the first side surface and being away from the other light guide plate;
two first light sources arranged adjacent to the second side surfaces of the two light guide plates, respectively, and providing first light beams for the two light guide plates, respectively;
a diffusing plate arranged between the first side surfaces of the two light guide plates; and
a second light source arranged below the diffusing plate and providing second light beams for the diffusing plate.

15. The liquid crystal display of claim 14, wherein each of the first side surfaces of the two light guide plates comprises a first supporting member arranged thereon, and two end portions of the diffusing plate are supported on the first supporting members.

16. The liquid crystal display of claim 15, wherein the backlight module further comprises an optical film arranged above the light guide plates and the diffusing plate.

17. The liquid crystal display of claim 15, wherein the backlight module further comprises a bottom tray arranged below the light guide plates and the second light source, and the bottom tray supports the light guide plates and the second light source.

18. The liquid crystal display of claim 17, wherein the bottom tray comprises two first supporting portions apart from each other, and a downwardly depressed second supporting portion arranged between the two first supporting portions, the two light guide plates being supported on the two first supporting portions and the second light source being supported on the second supporting portion.

19. The liquid crystal display of claim 18, wherein the bottom tray further comprises two second supporting members, and other two end portions of the diffusing plate are supported on the second supporting members of the bottom tray.

20. The liquid crystal display of claim 14, wherein the first light beams from the first light sources enter into the diffusing plate via the light guide plates.
